(19) United States
(12) Patent Application Publication
(10) Pub. No.: US 2025/0335245 A1
(43) Pub. Date: Oct. 30, 2025

(54) METHOD FOR SCHEDULING MULTIPLE WORKFLOWS BASED ON MULTIPLE KUBERNETES CLUSTERS AND APPARATUS FOR THE SAME

(71) Applicant: Electronics and Telecommunications Research Institute, Daejeon (KR)

(72) Inventors: Soo-Young KIM, Daejeon (KR); Dong-Jae KANG, Daejeon (KR); Byoung-Seob KIM, Sejong-si (KR); Yun-Kon KIM, Daejeon (KR); Seung-Jo BAE, Daejeon (KR); Seok-Ho SON, Daejeon (KR); Byeong-Thaek OH, Sejong-si (KR); Young-Woo JUNG, Daejeon (KR)

(73) Assignee: Electronics and Telecommunications Research Institute, Daejeon (KR)

(21) Appl. No.: 18/968,090

(22) Filed: Dec. 4, 2024

(30) Foreign Application Priority Data
Apr. 30, 2024 (KR) 10-2024-0057422

(51) Int. Cl. G06F 9/48; G06F 9/50

(52) U.S. Cl. CPC G06F 9/4887; G06F 9/5005

(57) ABSTRACT

Disclosed herein are a method for scheduling multiple workflows based on multiple kubernetes clusters and an apparatus for the same. The method for scheduling multiple workflows based on multiple kubernetes clusters is performed by an apparatus for scheduling multiple workflows based on multiple kubernetes clusters, and includes analyzing specifications of multiple workflows that have not yet been executed, classifying a workflow to be newly executed based on information of the workflow specifications, selecting a target cluster that is capable of meeting a resource requirement of the workflow to be newly executed from among the multiple kubernetes clusters based on the information of the workflow specifications, and allocating the workflow to be newly executed to the target cluster and then executing the workflow.

### CROSS REFERENCE TO RELATED APPLICATION

This application claims the benefit of Korean Patent Application No. 10-2024-0057422, field Apr. 30, 2024, which is hereby incorporated by reference in its entirety into this application.

### BACKGROUND OF THE INVENTION

### 1. Technical Field

The present disclosure relates generally to technology for scheduling multiple workflows based on multiple kubernetes clusters, and more particularly to technology for cost-efficiently deploying and executing multiple workflows having various resource requirements in multiple kubernetes clusters distributed in multiple cloud environments.

### 2. Description of the Related Art

As the utility of Kubernetes starts to be widely known with the activation of a cloud market, various public cloud service providers are offering managed Kubernetes services such as Amazon Elastic Kubernetes Service (EKS), Google Kubernetes Engine (GKE), and Azure Kubernetes Service (AKS). Additionally, it is possible to utilize managed Kubernetes services in private cloud environments. In such cloud environment-based managed Kubernetes services, adding or removing worker nodes to or from a Kubernetes cluster can be easily processed, thus allowing the Kubernetes cluster to be utilized by adjusting the size of the Kubernetes cluster as needed. Furthermore, the number of worker nodes can be automatically adjusted within a range from the preset minimum number of worker nodes to the preset maximum number of worker nodes based on predefined criteria by providing a cluster autoscaling function.

Additionally, because various cloud service providers offer different types of virtual machines equipped with a variety of CPUs or GPUs at various prices, various types of virtual machines can be used at low cost as needed.

Meanwhile, in various fields, for machine learning for artificial intelligence or the effective utilization of diverse resources, workflow engines that are easier to use and provide excellent scalability have been developed and utilized. Here, multiple technologies for effectively handling workflows have been developed and utilized in Kubernetes clusters, with representative workflow engines including Argo Workflow, Tekton, and Kubeflow Pipeline. These workflow engines can sequentially or in parallel execute and manage respective tasks, defined in each workflow, based on containers.

However, a conventional method for utilizing workflow engines associated with multiple Kubernetes clusters has been limited to merely executing workflows separately on previously constructed Kubernetes clusters. As a result, there are limitations in effectively utilizing the resources of multiple Kubernetes clusters or utilizing cost-effective Kubernetes clusters on other clouds when needed.

### PRIOR ART DOCUMENTS

### Patent Documents

(Patent Document 1) Korean Patent Application Publication No. 10-2014-0066616, Date of Publication: Jun. 2, 2014 (Title: Method, Apparatus and System for Providing Cloud based Distributed-parallel Application Workflow Execution Service)

### SUMMARY OF THE INVENTION

Accordingly, the present disclosure has been made keeping in mind the above problems occurring in the prior art, and an object of the present disclosure is to minimize service operational cost for execution of workflows while keeping required workflow execution completion times, which are service quality constraints for respective workflows set by a user, when multiple workflows having various requirements are deployed and executed in multiple kubernetes clusters.

Another object of the present disclosure is to decrease scheduling complexity by applying a sliding window technique when multiple workflows are deployed and executed in multiple kubernetes clusters.

A further object of the present disclosure is to minimize total cluster operational cost for execution of all workflows by extending and providing service to worker nodes in which the minimum operational cost is calculated in the order of rare resources or by constructing cheap new clusters to provide the service when the service is provided using multiple workflows based on multiple kubernetes clusters.

In accordance with an aspect of the present disclosure to accomplish the above objects, there is provided a method for scheduling multiple workflows based on multiple kubernetes clusters, the method being performed by an apparatus for scheduling multiple workflows based on multiple kubernetes clusters, the method including analyzing specifications of multiple workflows that have not yet been executed; classifying a workflow to be newly executed based on information of the workflow specifications; selecting a target cluster that is capable of meeting a resource requirement of the workflow to be newly executed from among the multiple kubernetes clusters based on the information of the workflow specifications; and allocating the workflow to be newly executed to the target cluster and then executing the workflow.

The information of the workflow specifications includes a required execution completion time, resource requirements per unit time, a total estimated required time, and an estimated execution start time.

The estimated execution start time may be analyzed by back-calculating the required execution completion time and the total estimated required time.

The workflow to be newly executed may correspond to a workflow falling within a range of a time window in which the estimated execution start time is set at preset intervals among the multiple workflows that have not yet been executed.

Selecting the target cluster may include a first operation of calculating estimated operational cost for execution of the workflow to be newly executed, for a first cluster currently being operated; a second operation of calculating estimated operational cost for execution of the workflow to be newly executed, for a second cluster scheduled to be operated, including creation of a new cluster; and selecting a cluster for which the estimated operational cost is minimized between the first cluster and the second cluster as the target cluster.

The estimated operational cost may include estimated operational cost of a control plane and estimated operational cost of the worker nodes.

The first operation of calculating the estimated operational cost may include determining remaining resource requirements per unit time for workflows currently being executed in a 1-1-th cluster that is one cluster included in the first cluster and resource requirements per unit time for workflows scheduled to be executed in the 1-1-th cluster; summing resource requirements per unit time for the workflow to be newly executed, remaining resource requirements per unit time for the workflows currently being executed, and resource requirements per unit time for workflows scheduled to be executed; and calculating the estimated operational cost of the worker nodes in consideration of a result of summing the resource requirements and a resource usage limit of the 1-1-th cluster.

Calculating the estimated operational cost of the worker nodes may include when the result of summing the resource requirements is within the resource usage limit of the 1-1-th cluster, calculating the estimated operational cost of the worker nodes in consideration of a part of operational cost of worker nodes that share resources with the workflows currently being executed or scheduled to be executed in 1-1-th cluster and total operational cost of worker nodes that do not share resources with the workflows currently being executed or scheduled to be executed in the 1-1-th cluster.

Calculating the estimated operational cost of the worker nodes may further include, when the result of summing the resource requirements exceeds the resource usage limit of the 1-1-th cluster, calculating the estimated operational cost of the worker nodes in consideration of total operational cost of new worker nodes enough to accommodate the result of summing the resource requirements.

Calculating the estimated operational cost of the worker nodes may further include, when a cluster management capacity exceeds a preset cluster management capacity of a control plane of the 1-1-th cluster due to the new worker nodes, determining that the 1-1-th cluster is not suitable as the target cluster, and calculating the estimated operational cost for a 1-2-th cluster that is a next cluster.

The second operation of calculating the estimated operational cost may include calculating the estimated operational cost of the worker nodes in consideration of resource requirements per unit time for the workflow to be newly executed and a resource usage limit of worker nodes scheduled to be operated in a 2-1-th cluster that is one cluster included in the second cluster.

When the resource requirements per unit time for the workflow to be newly executed are within the resource usage limit of the worker nodes scheduled to be operated in the 2-1-th cluster that is one cluster included in the second cluster, the estimated operational cost of the worker nodes may be calculated in consideration of a part of operational cost of worker nodes that share resources with workflows scheduled to be executed in the 2-1-th cluster and total operational cost of worker nodes that do not share resources with the workflows scheduled to be executed in the 2-1-th cluster.

When the resource requirements per unit time for the workflow to be newly executed exceed the resource usage limit of worker nodes scheduled to be operated in the 2-1-th cluster that is one cluster included in the second cluster, the estimated operational cost of the worker nodes may be calculated in consideration of total operational cost of new worker nodes enough to accommodate the resource requirements per unit time for the workflow to be newly executed.

The second operation of calculating the estimated operational cost may further include, when a cluster management capacity exceeds a preset cluster management capacity of a control plane of the 2-1-th cluster due to the new worker nodes, determining that the 2-1-th cluster is not suitable as the target cluster, and calculating the estimated operational cost for a 2-2-th cluster that is a next cluster.

The estimated operational cost of the control plane may be calculated in accordance with a ratio of a usage time of the workflow to be newly executed to a sum of usage times of workflows scheduled to be executed and the usage time of the workflow to be newly executed in each cluster scheduled to be operated.

The estimated operational cost of the worker nodes may be calculated by preferentially considering rare resources, and the rare resources may correspond to resources that are usable only when the resources are additionally included, rather than resources essentially held by each worker node.

In accordance with another aspect of the present disclosure to accomplish the above objects, there is provided an apparatus for scheduling multiple workflows based on multiple kubernetes clusters, including a processor configured to analyze specifications of multiple workflows that have not yet been executed, classify a workflow to be newly executed based on information of the workflow specifications, select a target cluster that is capable of meeting a resource requirement of the workflow to be newly executed from among the multiple kubernetes clusters based on the information of the workflow specifications, and allocate the workflow to be newly executed to the target cluster and then executing the workflow; and memory configured to store the information of the workflow specifications.

The information of the workflow specifications may include a required execution completion time, resource requirements per unit time, a total estimated required time, and an estimated execution start time.

The workflow to be newly executed may correspond to a workflow falling within a range of a time window in which the estimated execution start time is set at preset intervals among the multiple workflows that have not yet been executed.

The processor may be configured to calculate estimated operational cost for execution of the workflow to be newly executed for a first cluster currently being operated, calculate estimated operational cost for execution of the workflow to be newly executed for a second cluster scheduled to be operated, including creation of a new cluster, and select a cluster, in which the estimated operational cost is minimized between the first cluster and the second cluster, as the target cluster.

The estimated operational cost may include estimated operational cost of a control plane and estimated operational cost of the worker nodes.

The processor may be configured to determine remaining resource requirements per unit time for workflows currently being executed in a 1-1-th cluster that is one cluster included in the first cluster and resource requirements per unit time for workflows scheduled to be executed in the 1-1-th cluster, sum resource requirements per unit time for the workflow to be newly executed, remaining resource requirements per unit time for the workflows currently being executed, and resource requirements per unit time for workflows scheduled to be executed, and calculate the estimated operational cost of the worker nodes in consideration of a result of summing the resource requirements and a resource usage limit of the 1-1-th cluster.

The processor may be configured to, when the result of summing the resource requirements is within the resource usage limit of the 1-1-th cluster, calculate the estimated operational cost of the worker nodes in consideration of a part of operational cost of worker nodes that share resources with the workflows currently being executed or scheduled to be executed in 1-1-th cluster and total operational cost of worker nodes that do not share resources with the workflows currently being executed or scheduled to be executed in the 1-1-th cluster.

The processor may be configured to, when the result of summing the resource requirements exceeds the resource usage limit of the 1-1-th cluster, calculate the estimated operational cost of the worker nodes in consideration of total operational cost of new worker nodes enough to accommodate the result of summing the resource requirements.

The processor may be configured to, when a cluster management capacity exceeds a preset cluster management capacity of a control plane of the 1-1-th cluster due to the new worker nodes, determine that the 1-1-th cluster is not suitable as the target cluster, and calculate the estimated operational cost for a 1-2-th cluster that is a next cluster.

The processor may be configured to calculate the estimated operational cost of the worker nodes in consideration of resource requirements per unit time for the workflow to be newly executed and a resource usage limit of worker nodes scheduled to be operated in a 2-1-th cluster that is one cluster included in the second cluster.

When the resource requirements per unit time for the workflow to be newly executed are within the resource usage limit of the worker nodes scheduled to be operated in the 2-1-th cluster that is one cluster included in the second cluster, the estimated operational cost of the worker nodes may be calculated in consideration of a part of operational cost of worker nodes that share resources with workflows scheduled to be executed in the 2-1-th cluster and total operational cost of worker nodes that do not share resources with the workflows scheduled to be executed in the 2-1-th cluster.

When the resource requirements per unit time for the workflow to be newly executed exceed the resource usage limit of worker nodes scheduled to be operated in the 2-1-th cluster that is one cluster included in the second cluster, the estimated operational cost of the worker nodes may be calculated in consideration of total operational cost of new worker nodes enough to accommodate the resource requirements per unit time for the workflow to be newly executed.

The processor may be configured to, when a cluster management capacity exceeds a preset cluster management capacity of a control plane of the 2-1-th cluster due to the new worker nodes, determine that the 2-1-th cluster is not suitable as the target cluster, and calculate the estimated operational cost for a 2-2-th cluster that is a next cluster.

The estimated operational cost of the control plane may be calculated in accordance with a ratio of a usage time of the workflow to be newly executed to a sum of usage times of workflows scheduled to be executed and the usage time of the workflow to be newly executed in each cluster scheduled to be operated.

The estimated operational cost of the worker nodes may be calculated by preferentially considering rare resources, and the rare resources may correspond to resources that are usable only when the resources are additionally included, rather than resources essentially held by each worker node.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram illustrating a system for scheduling multiple workflows based on multiple kubernetes clusters according to an embodiment of the present disclosure;

FIG. 2 is a diagram illustrating an example of the shape of a cluster in which multiple workflows are being executed according to the present disclosure;

FIG. 3 is an operation flowchart illustrating a method for scheduling multiple workflows based on multiple kubernetes clusters according to an embodiment of the present disclosure;

FIG. 4 is a diagram illustrating an example of a functional block for performing scheduling of multiple workflows according to the present disclosure;

FIG. 5 is a diagram illustrating the result of analyzing resource requirements per unit time for CPU resources for respective workflows according to the present disclosure;

FIG. 6 is a diagram illustrating the result of analysis illustrated in FIG. 5 based on time windows;

FIG. 7 is an operation flowchart illustrating in detail a process of selecting a target cluster in the method for scheduling multiple workflows according to an embodiment of the present disclosure;

FIG. 8 is an operation flowchart illustrating in detail a process of calculating the estimated operational costs of worker nodes in the method for scheduling multiple workflows according to an embodiment of the present disclosure; and

FIG. 9 is a block diagram illustrating an apparatus for scheduling multiple workflows based on multiple kubernetes clusters according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to make the gist of the present disclosure unnecessarily obscure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated to make the description clearer.

In the present specification, each of phrases such as “A or B”, “at least one of A and B”, “at least one of A or B”, “A, B, or C”, “at least one of A, B, and C”, and “at least one of A, B, or C” may include any one of the items enumerated together in the corresponding phrase, among the phrases, or all possible combinations thereof.

Hereinafter, embodiments of the present disclosure will be described in detail with reference to the attached drawings.

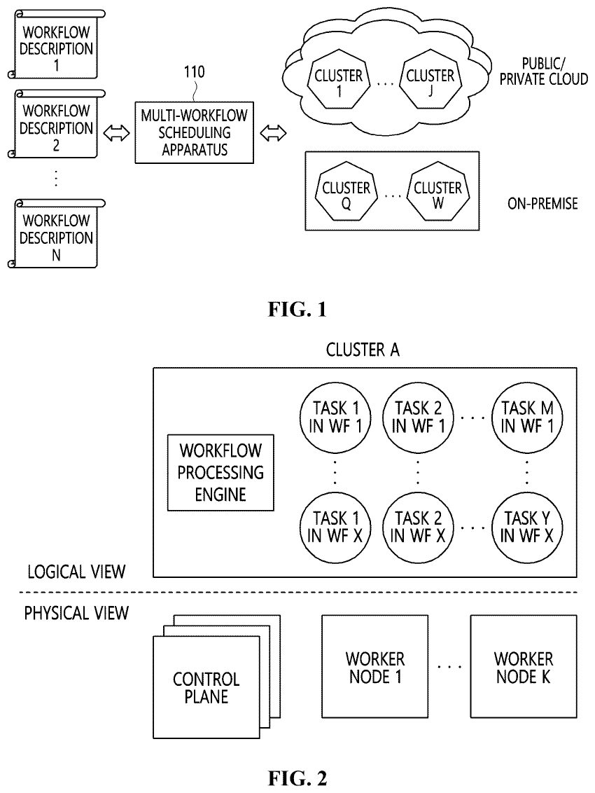

FIG. 1 is a diagram illustrating a system for scheduling multiple workflows based on multiple kubernetes clusters according to an embodiment of the present disclosure.

Referring to FIG. 1, in the system for scheduling multiple workflows based on multiple kubernetes clusters according to the embodiment of the present disclosure, an apparatus 110 for scheduling multiple workflows (hereinafter also referred to as a multi-workflow scheduling apparatus) may provide a function of effectively executing multiple workflows while managing multiple kubernetes clusters in conjunction with a public cloud, a private cloud, or on-premise environment.

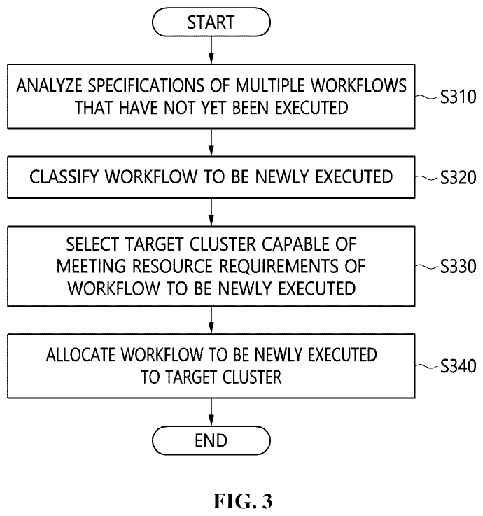

Here, in each kubernetes cluster, a workflow engine (or workflow processing engine) which can read and process the workflow specification of a user may be installed, as shown in FIG. 2, and the shape of the corresponding cluster appearing when which multiple workflows are executed may be considered from a logical view and a physical view.

Here, a method for operating each kubernetes cluster or a method for operating the workflow engine executed on the kubernetes cluster is technology out of the scope of the system desired to be proposed by the present disclosure, and thus detailed description thereof will be omitted.

FIG. 3 is an operation flowchart illustrating a method for scheduling multiple workflows based on multiple kubernetes clusters according to an embodiment of the present disclosure.

Referring to FIG. 3, in the method for scheduling multiple workflows based on multiple kubernetes clusters according to the embodiment of the present disclosure, an apparatus for scheduling multiple workflows based on multiple kubernetes clusters analyzes specifications of multiple workflows that have not yet been executed at step S310.

Also, in the method for scheduling multiple workflows based on multiple kubernetes clusters according to an embodiment of the present disclosure, the apparatus for scheduling multiple workflows based on multiple kubernetes clusters classifies a workflow to be newly executed based on information of the workflow specifications at step S320.

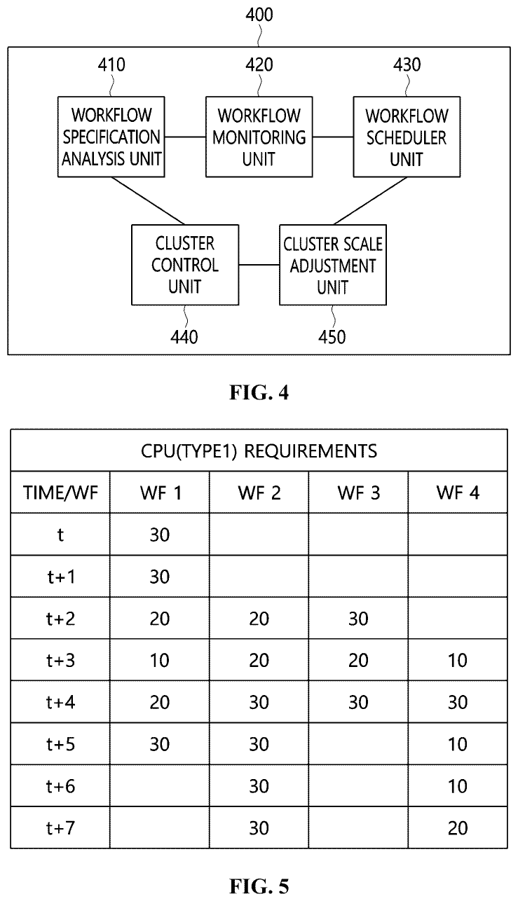

The apparatus for scheduling multiple workflows according to the embodiment of the present disclosure may be configured using functional blocks 410 to 450, such as those illustrated in FIG. 4.

For example, a workflow specification analysis unit 410 illustrated in FIG. 4 may analyze workflow specifications submitted by the user to determine required execution completion time for the corresponding workflow, resource requirements per unit time necessary for workflow execution, and total estimated time required for workflow execution, and may analyze the estimated execution start time for the workflow or the like by back-calculating the required execution completion time and the total estimated required time for the workflow.

The resource requirements to be analyzed in this way may include a Central Processing Unit (CPU) type, the number of CPU cores, CPU memory capacity, a Graphics Processing Unit (GPU) type, the number of GPUs, GPU memory capacity, a storage type (storage I/O performance), storage capacity, other devices, etc.

Here, the workflow to be newly executed may correspond to a workflow falling within the range of a time window in which estimated execution start times are set at preset intervals among multiple workflows that have not yet been executed.

For example, a workflow monitoring unit 420 illustrated in FIG. 4 may periodically identify and manage the state of the progress of each workflow being executed within the range of the time window by applying a sliding window technique. For example, it is possible to access the cluster in which each workflow is being executed and to determine and collect the execution location of the corresponding workflow, the usage states of respective resources per unit time, etc. Here, information about each resource to be collected may include CPU utilization, CPU temperature, CPU memory usage, GPU utilization, GPU temperature, GPU memory usage, storage I/O performance, network I/O performance, etc.

Here, a workflow scheduler unit 430 may determine and classify the workflow to be newly executed, which falls within the range of the time window, based on the information managed through the workflow monitoring unit 420.

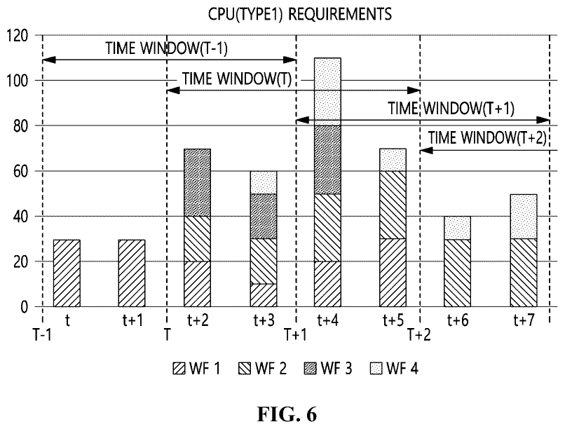

Hereinafter, a process of determining a workflow to be newly executed will be described in detail with reference to FIGS. 5 and 6.

FIG. 5 illustrates the result of analyzing resource requirements per unit time for CPU (TYPE1) resources for respective workflows over time (t to t+7) according to the present disclosure, and FIG. 6 is a diagram illustrating the result of analysis illustrated in FIG. 5 based on time windows.

Referring to FIGS. 5 and 6, workflows to be newly executed within the range of time windows that are set at preset intervals may be identified.

For example, it can be seen that unit times falling within the range of a time window T with respect to a time point T illustrated in FIG. 6 correspond to t+2 to t+5. Therefore, newly included workflows WF2, WF3, and WF4, which are newly included, during the unit times from t+2 to t+5, may be classified as the workflows to be newly executed according to the present disclosure.

Also, in the method for scheduling multiple workflows based on multiple kubernetes clusters according to an embodiment of the present disclosure, the apparatus for scheduling multiple workflows based on multiple kubernetes clusters selects a target cluster that is capable of meeting resource requirements of each workflow to be newly executed from among the multiple kubernetes clusters based on the workflow specification information at step S330.

In this case, when there are multiple workflows to be newly executed, the workflows may be sorted in order of the estimated execution start times from the earliest to the latest among the multiple workflows to be newly executed, and then the target cluster may be selected.

For example, the workflow scheduler unit 430 illustrated in FIG. 4 may select the target cluster that is capable of meeting resource requirements per unit time for each workflow to be newly executed, from among clusters currently being operated (including work nodes scheduled to be operated) or clusters scheduled to be subsequently operated (including worker nodes scheduled to be operated). That is, the multiple kubernetes clusters may include the clusters currently being operated (including worker nodes scheduled to be operated) or the clusters scheduled to be subsequently operated (including worker nodes scheduled to be operated).

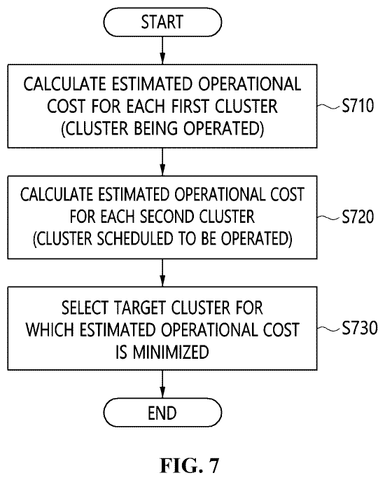

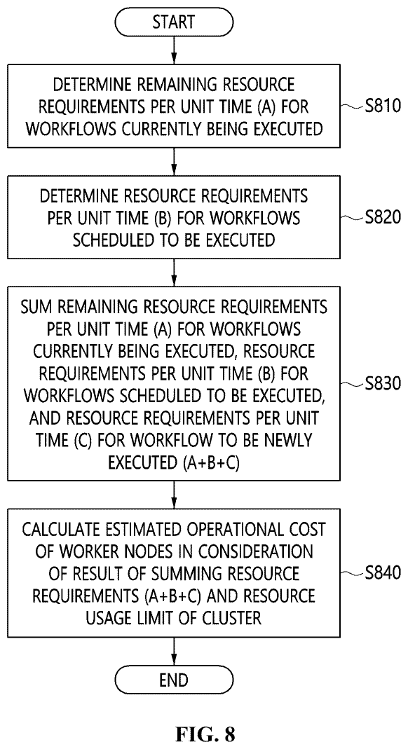

Hereinafter, the process in which the workflow scheduler unit 430 selects the target cluster will be described in detail with reference to the operation flowcharts illustrated in FIGS. 7 and 8.

First, referring to FIG. 7, estimated operational cost for execution of a workflow to be newly executed may be calculated for each first cluster that is currently being operated at step S710.

Here, the estimated operational cost may include the estimated operational cost of a control plane and the estimated operational costs of the worker nodes.

A process of calculating the estimated operational costs of worker nodes for the first cluster will be described in detail below with reference to FIG. 8.

Referring to FIG. 8, the remaining resource requirements per unit time (A) for workflows currently being executed in a 1-1-th cluster that is one cluster corresponding to the first cluster may be determined at step S810.

Thereafter, resource requirements per unit time (B) for workflows scheduled to be executed on the 1-1-th cluster may be determined at step S820.

Next, the remaining resource requirements per unit time (A) for the workflows currently being executed in the 1-1-th cluster, the resource requirements per unit time (B) for the workflows scheduled to be executed in the 1-1-th cluster, and resource requirements per unit time (C) for a workflow to be newly executed may be summed at step S830.

Thereafter, the estimated operational cost of the worker nodes may be calculated in consideration of the result of summing the resource requirements (A+B+C) and the resource usage limit of the 1-1-th cluster at step S840.

Here, the resource usage limit of the 1-1-th cluster may refer to the usage limit of resources held by the worker nodes that are either currently being operated or scheduled to be operated in the 1-1-th cluster.

Here, the estimated operational costs of the worker nodes may be calculated in the order of rare resources.

Here, the term “rare resources” may refer to resources, such as GPUs or other devices that are usable only when they are additionally included in worker nodes, rather than resources, such as CPUs or memory, essentially held by the worker nodes.

When the result of summing the resource requirements (A+B+C) is within the resource usage limit of the 1-1-th cluster at step S840, the estimated operational cost may be calculated by separating the worker nodes into sharing worker nodes which share resources with workflows that are currently being executed or scheduled to be executed in the 1-1-th cluster and non-sharing worker nodes which do not share resources with the workflows.

In the case of the sharing worker nodes, only a portion corresponding to the ratio of resource requirements per unit time (C) for the workflow to be newly executed to the operational cost of the sharing worker nodes may be calculated from the operational cost of the sharing worker nodes, and the calculated cost may be calculated as the estimated operational cost.

In the case of the non-sharing worker nodes, the total operational cost of the non-sharing worker nodes may be calculated as the estimated operational cost.

Meanwhile, when the result of summing the resource requirements (A+B+C) exceeds the resource usage limit of the 1-1-th cluster at step S840, addition of new worker nodes may be scheduled to be able to accommodate the entire result of summing the resource requirements (A+B+C), and the total operational cost of the new worker nodes may be calculated as the estimated operational cost.

In this case, the specifications of the new worker nodes may be considered such that the new worker nodes enough to accommodate all of insufficient resource requirements are created based on specifications having low operational cost per unit time while preferentially meeting insufficient rare resource requirements.

Here, the new worker nodes may be included in a list of worker nodes scheduled to be operated in the 1-1-th cluster.

Further, when cluster management capacity exceeds the preset cluster management capacity of the control plane of the 1-1-th cluster due to the scheduled addition of new worker nodes although the result of summing the resource requirements (A+B+C) exceeds the resource usage limit of the 1-1-th cluster at step S840 and then addition of the new worker nodes is scheduled, the process may perform a process of calculating estimated operational cost for the next cluster that is being operated.

That is, when the cluster management capacity exceeds the preset cluster management capacity of the control plane of the corresponding cluster in the case where new worker nodes are added, the corresponding cluster may be determined not to be suitable as the target cluster, and processing for the next cluster may be performed.

Here, a process of calculating the estimated operational cost of the control plane for the first cluster is described below.

First, the usage times of workflows currently being executed or scheduled to be executed in the first cluster and the usage time of the workflow to be newly executed in the first cluster may be summed. Thereafter, a portion corresponding to the ratio of the usage time of the workflow to be newly executed to the summed time may be calculated from the estimated operational cost of the control plane.

Thereafter, the workflow to be newly executed may be included in the list of workflows scheduled to be executed in the 1-1-th cluster, and the process of FIG. 8 may be performed for a 1-2-th cluster that is the next cluster being operated.

Meanwhile, referring to FIG. 7, the estimated operational cost for execution of the workflow to be newly executed may be calculated for each second cluster scheduled to be operated, including creation of a new cluster at step S720.

For example, creation of new clusters for respective cloud service providers may be assumed, and a list of clusters scheduled to be operated may be generated, after which the estimated operational cost for execution of the workflow to be newly executed within the range of a time window for each of the clusters scheduled to be operated may be calculated.

Here, the estimated operational cost may include the estimated operational cost of a control plane and the estimated operational costs of the worker nodes.

First, for resource requirements per unit time for the workflow to be newly executed, the estimated operational costs of worker nodes may be calculated in the order of rare resources.

For example, the resource requirements per unit time for the workflow to be newly executed and the resource usage limit of worker nodes scheduled to be operated in a 2-1-th cluster that is one cluster corresponding to the second cluster may be taken into consideration.

Here, the resource usage limit of the 2-1-th cluster may refer to the usage limit of resources held by the worker nodes scheduled to be operated in the 2-1-th cluster.

When the resource requirements per unit time for the workflow to be newly executed are within the resource usage limit of the worker nodes scheduled to be operated in the 2-1-th cluster, the estimated operational cost may be calculated by separating the worker nodes into sharing worker nodes which share resources with workflows scheduled to be executed in the 2-1-th cluster and non-sharing worker nodes which do not share the resources.by separating the worker nodes into sharing worker nodes which share resources with workflows that are currently being executed or scheduled to be executed in the 1-1-th cluster and non-sharing worker nodes which do not share resources with the workflows

In the case of the sharing worker nodes, only a portion corresponding to the ratio of resource requirements per unit time for the workflow to be newly executed to the operational cost of the sharing worker nodes may be calculated from the operational cost of the sharing worker nodes, and the calculated cost may be calculated as the estimated operational cost.

In the case of the non-sharing worker nodes, the total operational cost of the non-sharing worker nodes may be calculated as the estimated operational cost.

Further, when the resource requirements per unit time for the workflow to be newly executed exceed the resource usage limit of the worker nodes scheduled to be operated in the 2-1-th cluster, addition of new worker nodes may be scheduled be able to accommodate all resource requirements per unit time for the workflow to be newly executed, and then the total operational cost of the new worker nodes may be calculated as the estimated operational cost.

In this case, the specifications of the new worker nodes may be considered such that the new worker nodes enough to accommodate all of insufficient resource requirements are created based on specifications having low operational cost per unit time while preferentially meeting insufficient rare resource requirements.

Here, the new worker nodes may be included in a list of worker nodes scheduled to be operated in the 2-1-th cluster.

Further, when cluster management capacity exceeds the preset cluster management capacity of the control plane of the 2-1-th cluster due to the scheduled addition of new worker nodes although the resource requirements per unit time for the workflow to be newly executed exceed the resource usage limit of the worker nodes scheduled to be operated in the 2-1-th cluster and then addition of new worker nodes is scheduled, a process of calculating the estimated operational cost may be performed for the next cluster that is scheduled to be operated.

That is, when the cluster management capacity exceeds the preset cluster management capacity of the control plane of the corresponding cluster in the case where new worker nodes are added, the corresponding cluster may be determined not to be suitable as the target cluster, and processing for the next cluster may be performed.

Here, a process of calculating the estimated operational cost of the control plane for the second cluster is described below.

First, the usage times of workflows scheduled to be executed in the second cluster and the usage time of the workflow to be newly executed in the second cluster may be summed. Thereafter, a portion corresponding to the ratio of the usage time of the workflow to be newly executed to the summed time may be calculated from the estimated operational cost of the control plane.

Thereafter, the workflow to be newly executed may be included in the list of workflows scheduled to be executed in the 2-1-th cluster, and the process at step S720 may be performed for a 2-2-th cluster that is the next cluster being operated.

Further, referring to FIG. 7, of the first cluster and the second cluster, the cluster for which the estimated operational cost is minimized may be selected as the target cluster at step S730.

Furthermore, in the method for scheduling multiple workflows based on multiple kubernetes clusters according to an embodiment of the present disclosure, the apparatus for scheduling multiple workflows based on multiple kubernetes clusters allocates the workflow to be newly executed to the target cluster to execute the workflow at step S340.

For example, when the estimated execution start time of the workflow to be newly executed is reached, the workflow scheduler unit 430 illustrated in FIG. 4 may function to allocate the workflow to be newly executed to the target cluster and execute the workflow.

In addition, a cluster scale adjustment unit 450 illustrated in FIG. 4 may individually determine and create worker nodes scheduled to be operated in the clusters currently being operated, clusters scheduled to be operated, and worker nodes scheduled to be operated in the clusters scheduled to be operated, at regular intervals. Furthermore, the cluster scale adjustment unit 450 may also function to determine worker nodes that are not scheduled to be operated, among the worker nodes included in the clusters currently being operated and then remove the worker nodes.

Furthermore, a cluster control unit 440 illustrated in FIG. 4 may function to access kubernetes services provided by multiple cloud service providers and control the kubernetes clusters. For example, it may be possible to create or remove clusters and to add or remove worker nodes. A method of adding or removing worker nodes may include a method of directly requesting addition or removal of a worker node and a method of directly processing the addition or removal by adjusting the minimum number of worker nodes or the maximum number of worker nodes using a cluster autoscaling function.

By means of the method for scheduling multiple workflows based on multiple kubernetes clusters, service operational cost for execution of workflows may be minimized while required workflow execution completion times, which are service quality constraints for respective workflows set by a user, are kept when multiple workflows having various requirements are deployed and executed in multiple kubernetes clusters.

Further, when multiple workflows are deployed and executed in multiple kubernetes clusters, scheduling complexity may be decreased by applying a sliding window technique.

Furthermore, total cluster operational cost for execution of all workflows may be minimized by extending and providing service to worker nodes in which the minimum operational cost is calculated in the order of rare resources or by constructing cheap new clusters to provide the service when the service is provided using multiple workflows based on multiple kubernetes clusters.

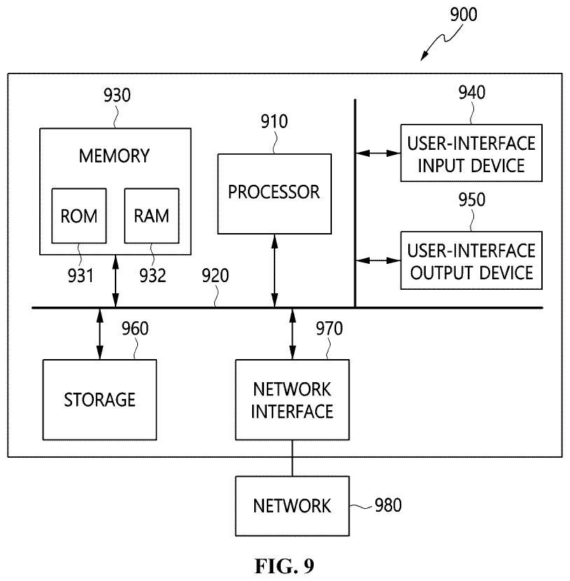

FIG. 9 is a block diagram illustrating an apparatus for scheduling multiple workflows based on multiple kubernetes clusters according to an embodiment of the present disclosure.

Referring to FIG. 9, the apparatus for scheduling multiple workflows based on multiple kubernetes clusters according to the embodiment of the present disclosure may be implemented in a computer system such as a computer-readable storage medium. As shown in FIG. 9, a computer system 900 may include one or more processors 910, memory 930, a user interface input device 940, a user interface output device 950, and storage 960, which communicate with each other through a bus 920. The computer system 900 may further include a network interface 970 connected to a network 980. Each processor 910 may be a Central Processing Unit (CPU) or a semiconductor device for executing programs or processing instructions stored in the memory 930 or the storage 960. Each of the memory 930 and the storage 960 may be any of various types of volatile or nonvolatile storage media. For example, the memory 930 may include Read-Only Memory (ROM) 931 or Random Access Memory (RAM) 932.

Therefore, the embodiment of the present disclosure may be implemented as a non-transitory computer-readable medium in which a computer-implemented method or computer-executable instructions are stored. When the computer-readable instructions are executed by the processor, the computer-readable instructions may perform the method according to at least one aspect of the present disclosure.

The processor 910 analyzes specifications of multiple workflows that have not yet been executed.

Further, the processor 910 classifies a workflow to be newly executed based on information of the workflow specifications.

Here, the workflow specification information may include required execution completion time, resource requirements per unit time, total estimated required time, and estimated execution start time.

Here, the estimated execution start time may be analyzed by back-calculating the required execution completion time and the total estimated required time.

Here, the workflow to be newly executed may correspond to a workflow falling within the range of a time window in which the estimated execution start times are set at preset intervals among multiple workflows that have not yet been executed.

Further, the processor 910 selects a target cluster that is capable of meeting the resource requirements of the workflow to be newly executed from among the multiple kubernetes clusters based on the workflow specification information.

Here, the processor 910 may be configured to calculate estimated operational cost for execution of the workflow to be newly executed for the first cluster in operation, calculate estimated operational cost for execution of the workflow to be newly executed for a second cluster scheduled to be operated, including creation of a new cluster, and select a cluster, in which the estimated operational cost is minimized between the first cluster and the second cluster, as the target cluster.

Here, the estimated operational cost may include the estimated operational cost of a control plane and the estimated operational costs of worker nodes.

Here, the processor 910 may be configured to determine the remaining resource requirements per unit time for workflows currently being executed in a 1-1-th cluster that is one cluster included in the first cluster and resource requirements per unit time for workflows scheduled to be executed in the 1-1-th cluster, sum resource requirements per unit time for the workflow to be newly executed, remaining resource requirements per unit time for the workflows currently being executed, and resource requirements per unit time for workflows scheduled to be executed, and calculate the estimated operational cost of the worker nodes in consideration of the result of summing the resource requirements and a resource usage limit of the 1-1-th cluster.

Here, the processor 910 may be configured to, when the result of summing the resource requirements is within the resource usage limit of the 1-1-th cluster, calculate the estimated operational cost of the worker nodes in consideration of a part of operational cost of worker nodes that share resources with the workflows currently being executed or scheduled to be executed in 1-1-th cluster and total operational cost of worker nodes that do not share resources with the workflows currently being executed or scheduled to be executed in the 1-1-th cluster.

The processor 910 may be configured to, when the result of summing the resource requirements exceeds the resource usage limit of the 1-1-th cluster, calculate the estimated operational cost of the worker nodes in consideration of total operational cost of new worker nodes enough to accommodate the result of summing the resource requirements.

The processor 910 may be configured to, when a cluster management capacity exceeds a preset cluster management capacity of a control plane of the 1-1-th cluster due to the new worker nodes, determine that the 1-1-th cluster is not suitable as the target cluster, and calculate the estimated operational cost for a 1-2-th cluster that is a next cluster.

The processor 910 may be configured to calculate the estimated operational cost of the worker nodes in consideration of resource requirements per unit time for the workflow to be newly executed and a resource usage limit of worker nodes scheduled to be operated in a 2-1-th cluster that is one cluster included in the second cluster.

When the resource requirements per unit time for the workflow to be newly executed are within the resource usage limit of the worker nodes scheduled to be operated in the 2-1-th cluster that is one cluster included in the second cluster, the estimated operational cost of the worker nodes may be calculated in consideration of a part of operational cost of worker nodes that share resources with workflows scheduled to be executed in the 2-1-th cluster and total operational cost of worker nodes that do not share resources with the workflows scheduled to be executed in the 2-1-th cluster.

When the resource requirements per unit time for the workflow to be newly executed exceed the resource usage limit of worker nodes scheduled to be operated in the 2-1-th cluster that is one cluster included in the second cluster, the estimated operational cost of the worker nodes may be calculated in consideration of total operational cost of new worker nodes enough to accommodate the resource requirements per unit time for the workflow to be newly executed.

The processor 910 may be configured to, when a cluster management capacity exceeds a preset cluster management capacity of a control plane of the 2-1-th cluster due to the new worker nodes, determine that the 2-1-th cluster is not suitable as the target cluster, and calculate the estimated operational cost for a 2-2-th cluster that is a next cluster.

The estimated operational cost of the control plane may be calculated in accordance with a ratio of a usage time of the workflow to be newly executed to the sum of usage times of workflows scheduled to be executed and the usage time of the workflow to be newly executed in each cluster scheduled to be operated.

The estimated operational cost of the worker nodes may be calculated by preferentially considering rare resources, and the rare resources may correspond to resources that are usable only when the resources are additionally included, rather than resources essentially held by each worker node.

Furthermore, the processor 910 may allocate the workflow to be newly executed to the target cluster and execute the workflow.

The memory 930 may store the workflow specification information.

In accordance with an embodiment, the memory 930 may be configured independently of the apparatus for scheduling multiple workflows based on multiple kubernetes clusters, and may then support a function for scheduling multiple workflows based on multiple kubernetes clusters. Here, the memory 930 may function as separate mass storage, and may include a control function for performing operations.

Meanwhile, the apparatus for scheduling multiple workflows based on multiple kubernetes clusters may be equipped with memory to store information in the apparatus.

In an embodiment, the memory may be a computer-readable medium. In an embodiment, the memory may be a volatile memory unit, and in another embodiment, the memory may be a nonvolatile memory unit. In an embodiment, a storage device may be a computer-readable medium. In various different embodiments, the storage device may be, for example, a hard disk device, an optical disk device, or another type of mass storage device.

By means of the apparatus for scheduling multiple workflows based on multiple kubernetes clusters, service operational cost for execution of workflows may be minimized while required workflow execution completion times, which are service quality constraints for respective workflows set by a user, are kept when multiple workflows having various requirements are deployed and executed in multiple kubernetes clusters.

Further, when multiple workflows are deployed and executed in multiple kubernetes clusters, scheduling complexity may be decreased by applying a sliding window technique.

Furthermore, total cluster operational cost for execution of all workflows may be minimized by extending and providing service to worker nodes in which the minimum operational cost is calculated in the order of rare resources or by constructing cheap new clusters to provide the service when the service is provided using multiple workflows based on multiple kubernetes clusters.

According to the present disclosure, service operational cost for execution of workflows may be minimized while required workflow execution completion times, which are service quality constraints for respective workflows set by a user, are kept when multiple workflows having various requirements are deployed and executed in multiple kubernetes clusters.

Further, the present disclosure may decrease scheduling complexity by applying a sliding window technique when multiple workflows are deployed and executed in multiple kubernetes clusters.

Furthermore, the present disclosure may minimize total cluster operational cost for execution of all workflows by extending and providing service to worker nodes in which the minimum operational cost is calculated in the order of rare resources or by constructing cheap new clusters to provide the service when the service is provided using multiple workflows based on multiple kubernetes clusters.

As described above, in the method for scheduling multiple workflows based on multiple kubernetes clusters and the apparatus for the method according to the present disclosure, the configurations and schemes in the above-described embodiments are not limitedly applied, and some or all of the above embodiments can be selectively combined and configured so that various modifications are possible.

What is claimed is:

1. A method for scheduling multiple workflows based on multiple kubernetes clusters, the method being performed by an apparatus for scheduling multiple workflows based on multiple kubernetes clusters, the method comprising:
analyzing specifications of multiple workflows that have not yet been executed;
classifying a workflow to be newly executed based on information of the workflow specifications;
selecting a target cluster that is capable of meeting a resource requirement of the workflow to be newly executed from among the multiple kubernetes clusters based on the information of the workflow specifications; and
allocating the workflow to be newly executed to the target cluster and then executing the workflow.

2. The method of claim 1, wherein the information of the workflow specifications includes a required execution completion time, resource requirements per unit time, a total estimated required time, and an estimated execution start time.

3. The method of claim 2, wherein the estimated execution start time is analyzed by back-calculating the required execution completion time and the total estimated required time.

4. The method of claim 2, wherein the workflow to be newly executed corresponds to a workflow falling within a range of a time window in which the estimated execution start time is set at preset intervals among the multiple workflows that have not yet been executed.

5. The method of claim 2, wherein selecting the target cluster comprises:
a first operation of calculating estimated operational cost for execution of the workflow to be newly executed, for a first cluster currently being operated;
a second operation of calculating estimated operational cost for execution of the workflow to be newly executed, for a second cluster scheduled to be operated, including creation of a new cluster; and
selecting a cluster for which the estimated operational cost is minimized between the first cluster and the second cluster as the target cluster.

6. The method of claim 5, wherein the estimated operational cost includes estimated operational cost of a control plane and estimated operational cost of the worker nodes.

7. The method of claim 6, wherein the first operation of calculating the estimated operational cost comprises:
determining remaining resource requirements per unit time for workflows currently being executed in a 1-1-th cluster that is one cluster included in the first cluster and resource requirements per unit time for workflows scheduled to be executed in the 1-1-th cluster;
summing resource requirements per unit time for the workflow to be newly executed, remaining resource requirements per unit time for the workflows currently being executed, and resource requirements per unit time for workflows scheduled to be executed; and
calculating the estimated operational cost of the worker nodes in consideration of a result of summing the resource requirements and a resource usage limit of the 1-1-th cluster.

8. The method of claim 7, wherein calculating the estimated operational cost of the worker nodes comprises:
when the result of summing the resource requirements is within the resource usage limit of the 1-1-th cluster, calculating the estimated operational cost of the worker nodes in consideration of a part of operational cost of worker nodes that share resources with the workflows currently being executed or scheduled to be executed in 1-1-th cluster and total operational cost of worker nodes that do not share resources with the workflows currently being executed or scheduled to be executed in the 1-1-th cluster.

9. The method of claim 8, wherein calculating the estimated operational cost of the worker nodes further comprises:
when the result of summing the resource requirements exceeds the resource usage limit of the 1-1-th cluster, calculating the estimated operational cost of the worker nodes in consideration of total operational cost of new worker nodes enough to accommodate the result of summing the resource requirements.

10. The method of claim 9, wherein calculating the estimated operational cost of the worker nodes further comprises:
when a cluster management capacity exceeds a preset cluster management capacity of a control plane of the 1-1-th cluster due to the new worker nodes, determining that the 1-1-th cluster is not suitable as the target cluster, and calculating the estimated operational cost for a 1-2-th cluster that is a next cluster.

11. The method of claim 6, wherein the second operation of calculating the estimated operational cost comprises:
calculating the estimated operational cost of the worker nodes in consideration of resource requirements per unit time for the workflow to be newly executed and a resource usage limit of worker nodes scheduled to be operated in a 2-1-th cluster that is one cluster included in the second cluster.

12. The method of claim 11, wherein, when the resource requirements per unit time for the workflow to be newly executed are within the resource usage limit of the worker nodes scheduled to be operated in the 2-1-th cluster that is one cluster included in the second cluster, the estimated operational cost of the worker nodes is calculated in consideration of a part of operational cost of worker nodes that share resources with workflows scheduled to be executed in the 2-1-th cluster and total operational cost of worker nodes that do not share resources with the workflows scheduled to be executed in the 2-1-th cluster.

13. The method of claim 12, wherein, when the resource requirements per unit time for the workflow to be newly executed exceed the resource usage limit of worker nodes scheduled to be operated in the 2-1-th cluster that is one cluster included in the second cluster, the estimated operational cost of the worker nodes is calculated in consideration of total operational cost of new worker nodes enough to accommodate the resource requirements per unit time for the workflow to be newly executed.

14. The method of claim 13, wherein the second operation of calculating the estimated operational cost further comprises:
when a cluster management capacity exceeds a preset cluster management capacity of a control plane of the 2-1-th cluster due to the new worker nodes, determining that the 2-1-th cluster is not suitable as the target cluster, and calculating the estimated operational cost for a 2-2-th cluster that is a next cluster.

15. The method of claim 6, wherein the estimated operational cost of the control plane is calculated in accordance with a ratio of a usage time of the workflow to be newly executed to a sum of usage times of workflows scheduled to be executed and the usage time of the workflow to be newly executed in each cluster scheduled to be operated.

16. The method of claim 6, wherein:
the estimated operational cost of the worker nodes is calculated by preferentially considering rare resources, and
the rare resources correspond to resources that are usable only when the resources are additionally included, rather than resources essentially held by each worker node.

17. An apparatus for scheduling multiple workflows based on multiple kubernetes clusters, comprising:
a processor configured to analyze specifications of multiple workflows that have not yet been executed, classify a workflow to be newly executed based on information of the workflow specifications, select a target cluster that is capable of meeting a resource requirement of the workflow to be newly executed from among the multiple kubernetes clusters based on the information of the workflow specifications, and allocate the workflow to be newly executed to the target cluster and then executing the workflow; and
a memory configured to store the information of the workflow specifications.

18. The apparatus of claim 17, wherein the information of the workflow specifications includes a required execution completion time, resource requirements per unit time, a total estimated required time, and an estimated execution start time.

19. The apparatus of claim 18, wherein the workflow to be newly executed corresponds to a workflow falling within a range of a time window in which the estimated execution start time is set at preset intervals among the multiple workflows that have not yet been executed.

20. The apparatus of claim 18, wherein the processor is configured to calculate estimated operational cost for execution of the workflow to be newly executed for a first cluster currently being operated, calculate estimated operational cost for execution of the workflow to be newly executed for a second cluster scheduled to be operated, including creation of a new cluster, and select a cluster, in which the estimated operational cost is minimized between the first cluster and the second cluster, as the target cluster.
